(19) United States
(12) Patent Application Publication
(10) Pub. No.: US 2026/0108056 A1
(43) Pub. Date: Apr. 23, 2026

(54) DENTAL CARE DEVICE WITH WATER FLOSSING AND BRUSHING INTEGRATION

(71) Applicant: GENSHENG ZHANG, Hefei (CN)

(72) Inventor: GENSHENG ZHANG, Hefei (CN)

(21) Appl. No.: 18/919,773

(22) Filed: Oct. 18, 2024

(51) Int. Cl. A46B 13/04; A46B 9/04; A46B 11/00; A46B 11/08; A46B 13/02; A46B 15/00; A61C 17/02; A61C 17/34

(52) U.S. Cl. CPC A46B 13/04; A46B 9/04; A46B 11/0062; A46B 11/08; A46B 13/023; A46B 15/0036; A46B 15/0095; A61C 17/0202; A61C 17/3481

(57) ABSTRACT

The Invention discloses a dental care device with water flossing and brushing integration, comprising a device body whose inner wall is provided with a metal main shaft. For use, inject clear water into a water tank, and then enable sealing via a fully softened plug cover; press a start key, supply water via a water absorption tube, conduct filtration via a filter bulb; subsequently, choose different gear control and time reminder functions, and then start a built-in servo motor to make soft bristle brush oscillate and vibrate at a high frequency and join ultrasonic wave in cleaning oral cavity; finally, enable charging via a wireless charging base, so the dental care device with water flossing and brushing integration is completed.

### TECHNICAL FIELD

The Invention relates to the field of semiconductor machining technology and is specifically a dental care device with water flossing and brushing integration.

### BACKGROUND

The dental care device with water flossing and brushing integration is a portable, detachable dental care product with cordless charging which integrates toothbrush, electric oscillating and brushing, ultrasonic wave, oscillation and vibration amplitude adjustable to more than 60 degrees, offset correction and dental water jet. When used, the manual and electric toothbrushes available in the market will cause damage to the spaces around teeth and to gums, and their use is accompanied by incomplete removal of food residue and debris, making it easy to cause periodontitis, gum redness and swelling as well as other oral inflammations. Moreover, manual toothbrush, electric toothbrush, dental water jet, oral irrigator, among others, if fully made available, entail great expense, and are not easy to carry, place, store and clean. In the case of charging, the electric cleaning products available in the market need to be connected to USB cables, making it inconvenient to use. Therefore, in order to solve the above problems, we need a dental care device with water flossing and brushing integration.

Furthermore, the previously used dental care products are less diverse in function and limited in practicability, and they fail to thoroughly clean oral cavity, making it easy to breed bacteria and cause oral inflammations; when they rinse oral cavity, they fail to perform integrated functions including ultrasonic wave flushing, tooth brushing, pulse flushing, tooth brushing, variable frequency flushing, flushing with water temperature regulation, brushing, and they also fail to enable wireless charging.

### SUMMARY

The purpose of the Invention is to provide a dental care device with water flossing and brushing integration for solving the problems identified in the above background of the Invention.

For the above purpose, the Invention offers the following technical scheme:

The dental care device with water flossing and brushing integration comprises a device body, whose inner wall is provided with a metal main shaft, wherein the top of the said metal main shaft is provided with a brush head; the side wall of the said brush head is provided with cleaning particles; the inner wall of the said brush head is provided with a fixing sleeve; the inner wall of the fixing sleeve is provided with a hollow panel; the side wall of the said hollow panel is provided with a soft bristle brush; the outer wall of the said fixing sleeve is provided with a sandwich metal laminate; the side wall of the said device body is provided with a gear control key; the side wall of the said device body is provided with an intelligent mode control key; the side wall of the said device body is provided with a start key; the side wall of the said device body is provided with a water tank; the top of the said water tank has a water injection sink; the top of the said water tank is provided with a rotating shaft; the outer wall of the said rotating shaft is provided with a fully softened plug cover; the inner wall on the bottom of the said water tank is provided with an intelligent heating wire; the bottom of the said water tank is provided with a support rod; the inner wall of the said water tank is provided with a water absorption tube; the bottom of the said water absorption tube is provided with a filter bulb; the outer wall on the bottom of the said device body is provided with an all-round light; the bottom of the said device body is provided with a wireless charging base.

Preferably, there is plug connection between the said device body and the brush head; the said cleaning particles feature uniformly-spaced distribution with the central axis of the brush head as the center.

Preferably, the said sandwich metal laminate serves as counterweight; the inner wall of the said hollow panel features open water hole design.

Preferably, the said hollow panel is connected to the water sink within the device body; the oscillation and vibration amplitude of the said soft bristle brush could reach 60 degrees.

Preferably, the said hollow panel is connected to the water sink within the device body; the said soft bristle brush could vibrate at a high frequency.

Preferably, the said soft bristle brush is electrically connected to a built-in servo motor via the metal main shaft; the built-in servo motor could drive extension and retraction of the metal main shaft, and enable upward, downward pulling and resulting displacement for cleaning and brushing teeth.

A usage method for the dental care device with water flossing and brushing integration comprises the following steps:
S1. Lift the fully softened plug cover by rotating it around the rotating shaft, and then inject clear water into the water tank via the water injection sink; subsequently, reversely rotate the fully softened plug cover to enable clamp fixing with the water injection sink (13) for sealing;
S2. Press the start key to start the built-in driven water pump, and supply water via the water absorption tube; conduct filtration via the filter bulb to improve the cleanliness of oral cavity; heat clear water within the water tank via the intelligent heating wire to the extent that the temperature of clear water does not exceed 35 degrees centigrade when it is entering oral cavity;
S3. Based on user demand, press and adjust the gear control key and the intelligent mode control key; choose different gear control and time reminder functions, and control dental water jet, oral irrigator to be used alone or alternately; users are encouraged to develop a healthy tooth brushing habit;
S4. Subsequently, start the built-in servo motor to make the soft bristle brush oscillate and vibrate at a high frequency, and join ultrasonic wave in cleaning oral cavity, thus improving the cleaning effect;
S5. Finally, insert the device body into the wireless charging base for charging; the wireless charging base works under the principle of wireless mutual attraction so that automatic alignment and mutual attraction are enabled at a short distance to immediately conduct charging while preventing product capsizing; moreover, an all-round light glares so that the product can be normally charged and used in a dark room with insufficient light, thus use and operation of the dental care device with water flossing and brushing integration are completed.

Compared with the prior art, the Invention has the following beneficial effects:
1. The duly set brush head, cleaning particles, fixing sleeve, hollow panel, soft bristle brush and metal laminate are adopted; the brush head and the device body combine to feature a detachable design, making it easy to replace. Moreover, the surface of the brush head is decorated with food-grade RUBBER latex, and the cleaning particles at the back of the brush head could join the soft bristle brush in oscillating and vibrating teeth, and rub the intimas of oral cavity, massage and clean oral cavity; the hollow panel is provided with a water sink for ensuring that water is smoothly carried in tooth flushing and dental water jet; the hollow panel has an embedded bristle-based functional layer, while the soft bristle brush is driven by the built-in servo motor, which could enable high-frequency oscillation and vibration to improve the cleaning effect; the internal main coupling shaft features metal rotation; dynamic balancing and static balancing are highly matched; the degree of eccentricity is so low that it is negligible; rotation noise is low; this originates from circuit design plus hardware-IC new design.
2. The duly set gear control key, intelligent mode control key and start key are adopted; multiple gears could be controlled during tooth brushing, oscillation and vibration; there are multiple modes and intelligent reminder; dental water jet and oral irrigator are also in multiple cleaning modes, such as “Clean”, “Soft”, “WH./PL.” and “Polish”; in the case of use by children and senior citizens, “Gentle” gear could be chosen; in the case of removing debris between teeth, “Strong” gear could be chosen; this is highly humanized; first-time and sensitive users could choose “Soft” mode; there are built-in time intelligent timer and time pause reminder function; users are encouraged to develop a healthy tooth brushing habit.
3. The duly set water tank, water injection sink, rotating shaft, fully softened plug cover, support rod, water absorption tube and filter bulb are adopted; water tank is detachable, while the fully softened plug cover improves the sealing effect, and is lifted in the case of use, and it is convenient to add clear water and dispenses with dismounting; the internal water absorption tube is food-grade RUBBER tube; the bottom of the water absorption tube is provided with a filter bulb for filtering the injected clear water to improve the cleanliness of oral cavity.
4. The duly set all-round light and wireless charging base are adopted. The wireless charging base works under the principle of wireless mutual attraction so that automatic alignment and mutual attraction are enabled at a short distance to immediately conduct charging while preventing product capsizing; moreover, an all-round light glares so that the product can be normally charged and used in a dark room with insufficient light.

### BRIEF DESCRIPTION OF DRAWINGS

FIG. 1 shows the front view involving the structure of the Invention “dental care device with water flossing and brushing integration”;

FIG. 2 shows the side view involving the structure of the Invention “dental care device with water flossing and brushing integration”;

FIG. 3 shows the structural diagram involving internal components of the Invention “dental care device with water flossing and brushing integration”;

FIG. 4 shows the structural diagram involving enlarged Part A in FIG. 3 of the Invention “dental care device with water flossing and brushing integration”;

FIG. 5 shows the section view involving a portion of components of the Invention “dental care device with water flossing and brushing integration”;

FIG. 6 shows the structural diagram involving enlarged Part B in FIG. 5 of the Invention “dental care device with water flossing and brushing integration”;

### IN FIGURES

1. Device body; 2. Metal main shaft; 3. Brush head; 4. Cleaning particles; 5. Fixing sleeve; 6. Hollow panel; 7. Soft bristle brush; 8. Sandwich metal laminate; 9. Gear control key; 10. Intelligent mode control key; 11. Start key; 12. Water tank; 13. Water injection sink; 14. Rotating shaft; 15. Fully softened plug cover; 16. Intelligent heating wire; 17. Support rod; 18. Water absorption tube; 19. Filter bulb; 20. All-round light; 21. Wireless charging base.

### DESCRIPTION OF EMBODIMENTS

Based on the figures in the embodiments of the Invention, the technical scheme in the embodiments of the Invention is clearly, completely described below. Obviously, the described embodiments are only a portion of the Invention's embodiments rather all of embodiments. All of other embodiments obtained by general technical personnel in the field on the basis of the Invention's embodiments and on the premise of not making creative labor fall within the scope of protection by the Invention.

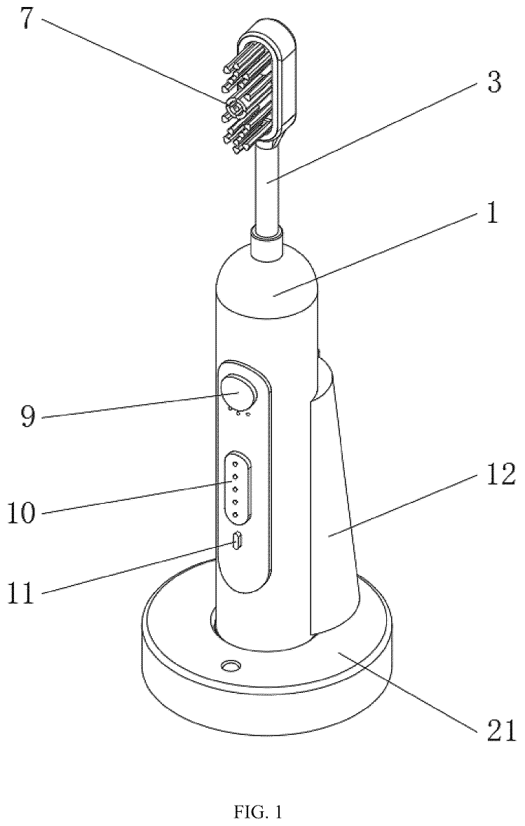

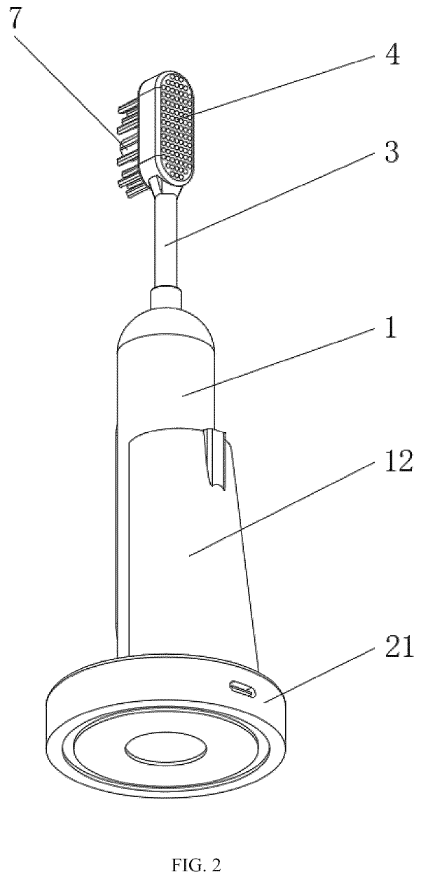

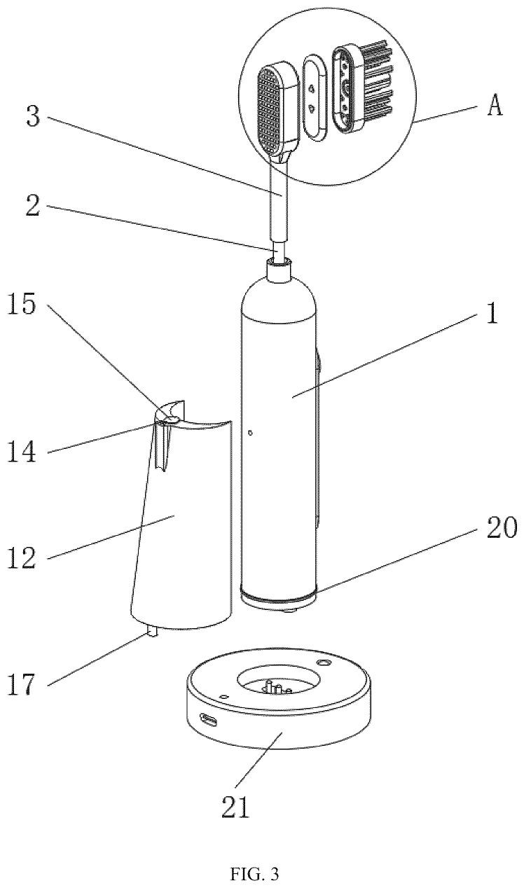

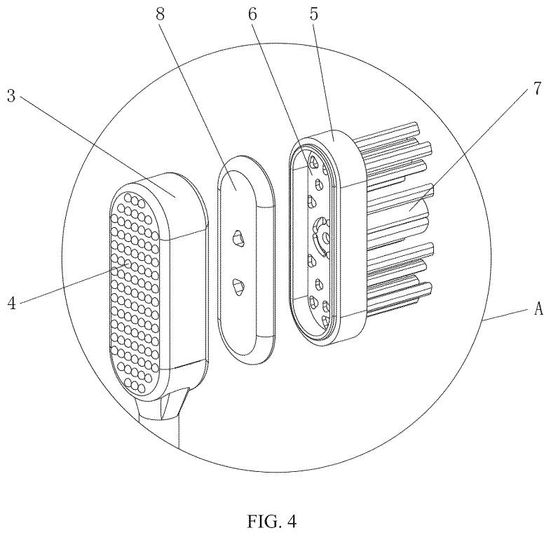

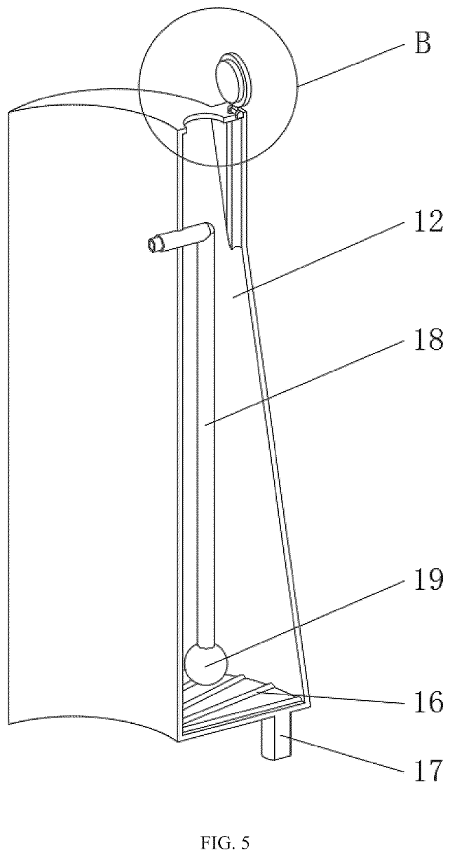

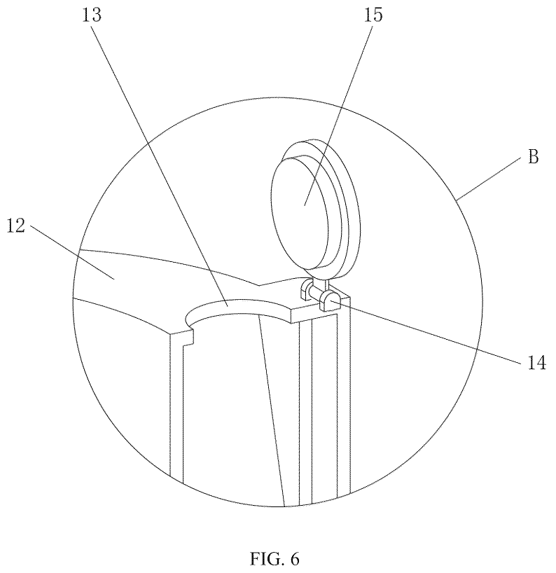

Please refer to FIGS. 1 to 6. The Invention offers the technical scheme of a dental care device with water flossing and brushing integration:

The dental care device with water flossing and brushing integration comprises a device body 1, whose inner wall is provided with a metal main shaft 2, wherein the top of the said metal main shaft 2 is provided with a brush head 3; the side wall of the said brush head 3 is provided with cleaning particles 4; the inner wall of the said brush head 3 is provided with a fixing sleeve 5; the inner wall of the fixing sleeve 5 is provided with a hollow panel 6; the side wall of the said hollow panel 6 is provided with a soft bristle brush 7; the outer wall of the said fixing sleeve 5 is provided with a sandwich metal laminate 8; the side wall of the said device body 1 is provided with a gear control key 9; the side wall of the said device body 1 is provided with an intelligent mode control key 10; the side wall of the said device body 1 is provided with a start key 11; the side wall of the said device body 1 is provided with a water tank 12; the top of the said water tank 12 has a water injection sink 13; the top of the said water tank 12 is provided with a rotating shaft 14; the outer wall of the said rotating shaft 14 is provided with a fully softened plug cover 15; the inner wall on the bottom of the said water tank 12 is provided with an intelligent heating wire 16; the bottom of the said water tank 12 is provided with a support rod 17; the inner wall of the said water tank 12 is provided with a water absorption tube 18; the bottom of the said water absorption tube 18 is provided with a filter bulb 19; the outer wall on the bottom of the said device body 1 is provided with an all-round light 20; the bottom of the said device body 1 is provided with a wireless charging base 21.

There is plug connection between the device body 1 and the brush head 3; the cleaning particles 4 feature uniformly-spaced distribution with the central axis of the brush head 3 as the center.

The sandwich metal laminate 8 serves as counterweight; the inner wall of the hollow panel 6 features open water hole design.

The hollow panel 6 is connected to the water sink within the device body 1; the oscillation and vibration amplitude of the said soft bristle brush 7 could reach 60 degrees.

The hollow panel 6 is connected to the water sink within the device body 1; the soft bristle brush 7 could vibrate at a high frequency.

The soft bristle brush 7 is electrically connected to a built-in servo motor via the metal main shaft 2; the built-in servo motor could drive extension and retraction of the metal main shaft 2, and enable upward, downward pulling and resulting displacement for cleaning and brushing teeth.

There is clamp connection between the water injection sink 13 and the fully softened plug cover 15; the fully softened plug cover 15 constitutes a flip structure, through the rotating shaft 14, along with the water tank 12.

The water absorption tube 18 supplies water via the driven water pump within the device body 1; there is plug connection between the said device body 1 and the wireless charging base 21.

The device body 1 features plug connection to the brush head 3 and has the function for automatic correction of offset; the brush head 3 is plugged into the device body 1 for offset correction and subsequently, permanent positioning is conducted, and it ensures that the soft bristle brush 7 and the function panel of the device body 1 share the same direction.

Clear water within the water tank 12 is heated via the intelligent heating wire 16 to the extent that water temperature does not exceed 35 degrees centigrade.

The usage method for the dental care device with water flossing and brushing integration comprises the following steps:
S1. Lift the fully softened plug cover 15 by rotating it around the rotating shaft 14, and then inject clear water into the water tank 12 via the water injection sink 13; subsequently, reversely rotate the fully softened plug cover 15 to enable clamp fixing with the water injection sink (13) for sealing;
S2. Press the start key 11 to start the built-in driven water pump, and supply water via the water absorption tube 18; conduct filtration via the filter bulb 19 to improve the cleanliness of oral cavity; heat clear water within the water tank 12 via the intelligent heating wire 16 to the extent that the temperature of clear water does not exceed 35 degrees centigrade when it is entering oral cavity;
S3. Based on user demand, press and adjust the gear control key 9 and the intelligent mode control key 10; choose different gear control and time reminder functions, and control dental water jet, oral irrigator to be used alone or alternately; users are encouraged to develop a healthy tooth brushing habit;
S4. Subsequently, start the built-in servo motor to make the soft bristle brush 7 oscillate and vibrate at a high frequency, and join ultrasonic wave in cleaning oral cavity, thus improving the cleaning effect;
S5. Finally, insert the device body 1 into the wireless charging base 21 for charging; the wireless charging base 21 works under the principle of wireless mutual attraction so that automatic alignment and mutual attraction are enabled at a short distance to immediately conduct charging while preventing product capsizing; moreover, an all-round light 20 glares so that the product can be normally charged and used in a dark room with insufficient light, thus use and operation of the dental care device with water flossing and brushing integration are completed.

Notably, the Invention is a dental care device with water flossing and brushing integration. When it is used, lift the fully softened plug cover 15 on top of the water tank 12, and then inject clear water into the water tank 12 via the water injection sink 13; subsequently, reversely rotate the fully softened plug cover 15 for sealing and closing; press the start key 11, and supply water via the water absorption tube 18; conduct filtration via the filter bulb 19; press and adjust the gear control key 9 and the intelligent mode control key 10; choose different gear control and time reminder functions, and then start the built-in servo motor to make the soft bristle brush 7 oscillate and vibrate at a high frequency, and join ultrasonic wave in cleaning oral cavity; finally, insert the device body 1 into the wireless charging base 21 for charging; turn on the all-round light 20 so that the product can be normally charged and used in a dark room with insufficient light, thus use and operation of the dental care device with water flossing and brushing integration are finished, and the dental care device with water flossing and brushing integration is completed.

Though the Invention's embodiments have been shown and described, it could be understood, for general technical personnel in the field, that these embodiments could be changed, modified, replaced and varied in many ways, subject to not breaking away from the Invention's principle and spirit; the scope of the Invention is defined by the attached claims and their equivalents.

What is claimed is:

1. A dental care device with water flossing and brushing integration, characterized in that it comprises a device body (1), whose inner wall is provided with a metal main shaft (2), wherein the top of the said metal main shaft (2) is provided with a brush head (3); the side wall of the said brush head (3) is provided with cleaning particles (4); the inner wall of the said brush head (3) is provided with a fixing sleeve (5); the inner wall of the fixing sleeve (5) is provided with a hollow panel (6); the side wall of the said hollow panel (6) is provided with a soft bristle brush (7); the outer wall of the said fixing sleeve (5) is provided with a sandwich metal laminate (8); the side wall of the said device body (1) is provided with a gear control key (9); the side wall of the said device body (1) is provided with an intelligent mode control key (10); the side wall of the said device body (1) is provided with a start key (11); the side wall of the said device body (1) is provided with a water tank (12); the top of the said water tank (12) has a water injection sink (13); the top of the said water tank (12) is provided with a rotating shaft (14); the outer wall of the said rotating shaft (14) is provided with a fully softened plug cover (15); the inner wall on the bottom of the said water tank (12) is provided with an intelligent heating wire (16); the bottom of the said water tank (12) is provided with a support rod (17); the inner wall of the said water tank (12) is provided with a water absorption tube (18); the bottom of the said water absorption tube (18) is provided with a filter bulb (19); the outer wall on the bottom of the said device body (1) is provided with an all-round light (20); the bottom of the said device body (1) is provided with a wireless charging base (21).

2. The dental care device with water flossing and brushing integration according to claim 1, characterized in that there is plug connection between the said device body (1) and the brush head (3); the said cleaning particles (4) feature uniformly-spaced distribution with the central axis of the brush head (3) as the center.

3. The dental care device with water flossing and brushing integration according to claim 1, characterized in that the said sandwich metal laminate (8) serves as counterweight;
the inner wall of the said hollow panel (6) features open water hole design.

4. The dental care device with water flossing and brushing integration according to claim 1, characterized in that the said hollow panel (6) is connected to the water sink within the device body (1); the oscillation and vibration amplitude of the said soft bristle brush (7) could reach 60 degrees.

5. The dental care device with water flossing and brushing integration according to claim 1, characterized in that the said hollow panel (6) is connected to the water sink within the device body (1); the said soft bristle brush (7) could vibrate at a high frequency.

6. The dental care device with water flossing and brushing integration according to claim 1, characterized in that the said soft bristle brush (7) is electrically connected to a built-in servo motor via the metal main shaft (2); the built-in servo motor could drive extension and retraction of the metal main shaft (2), and enable upward, downward pulling and resulting displacement for cleaning and brushing teeth.

7. The dental care device with water flossing and brushing integration according to claim 1, characterized in that there is clamp connection between the water injection sink (13) and the fully softened plug cover (15); the fully softened plug cover (15) constitutes a flip structure, through the rotating shaft (14), along with the water tank (12).

8. The dental care device with water flossing and brushing integration according to claim 1, characterized in that the water absorption tube (18) supplies water via the driven water pump within the device body (1); there is plug connection between the said device body (1) and the wireless charging base (21).

9. The dental care device with water flossing and brushing integration according to claim 1, characterized in that the said device body (1) features plug connection to the brush head (3) and has the function for automatic correction of offset; the brush head (3) is plugged into the device body (1) for offset correction and subsequently, permanent positioning is conducted, and it ensures that the soft bristle brush (7) and the function panel of the device body (1) share the same direction.

10. The dental care device with water flossing and brushing integration according to claim 1, characterized in that clear water within the said water tank (12) is heated via the intelligent heating wire (16) (water temperature shall not exceed 35 degrees centigrade).

11. A usage method for a dental care device with water flossing and brushing integration, characterized in that it comprises the following steps:
S1. Lift the fully softened plug cover (15) by rotating it around the rotating shaft (14), and then inject clear water into the water tank (12) via the water injection sink (13); subsequently, reversely rotate the fully softened plug cover (15) to enable clamp fixing with the water injection sink (13) for sealing;
S2. Press the start key (11) to start the built-in driven water pump, and supply water via the water absorption tube (18); conduct filtration via the filter bulb (19) to improve the cleanliness of oral cavity; heat clear water within the water tank (12) via the intelligent heating wire (16) to the extent that the temperature of clear water does not exceed 35 degrees centigrade when it is entering oral cavity;
S3. Based on user demand, press and adjust the gear control key (9) and the intelligent mode control key (10); choose different gear control and time reminder functions, and control dental water jet, oral irrigator to be used alone or alternately; users are encouraged to develop a healthy tooth brushing habit;
S4. Subsequently, start the built-in servo motor to make the soft bristle brush (7) oscillate and vibrate at a high frequency, and join ultrasonic wave in cleaning oral cavity, thus improving the cleaning effect;
S5. Finally, insert the device body (1) into the wireless charging base (21) for charging; the wireless charging base (21) works under the principle of wireless mutual attraction so that automatic alignment and mutual attraction are enabled at a short distance to immediately conduct charging while preventing product capsizing; moreover, an all-round light (20) glares so that the product can be normally charged and used in a dark room with insufficient light, thus use and operation of the dental care device with water flossing and brushing integration are completed.
